(19) United States
(12) Patent Application Publication
(10) Pub. No.: US 2015/0258844 A1
(43) Pub. Date: Sep. 17, 2015

(54) ANTLER MOUNTING STRUCTURE AND METHOD

(71) Applicant: LESLIE ALLEN BYRNS, SPRING CREEK, NV (US)

(72) Inventor: LESLIE ALLEN BYRNS, SPRING CREEK, NV (US)

(21) Appl. No.: 14/642,097

(22) Filed: Mar. 9, 2015

Related U.S. Application Data
(60) Provisional application No. 61/951,337, filed on Mar. 11, 2014.

(51) Int. Cl. B44C 5/02

(52) U.S. Cl. CPC B44C 5/02

(57) ABSTRACT

To mount the antlers or horns of an animal that have been harvested from an animal such as a deer or elk, a portion of the bark is removed from a section of tree trunk. The portion of bark that is removed is shaped to receive a filler in the shape of the head of the animal from which the antlers or horns have been harvested. The removed portion forms a cut out or recess through the bark into which the antlers or horns are secured and into which the filler is positioned. The filler is three dimensional and shaped much like the shape of the head of the animal from which the antlers or horn have been harvested. The filler is then covered with the cut out material which is the bark of the tree trunk to create a head like structure covered with bark with the antlers extending from their approximately natural location.

### BACKGROUND OF THE INVENTION

1. The Field

A structure and a method to mount the antlers of an animal are disclosed in which bark like material is removed from a base to form a cut out into which the antlers secured and into which a filler is positioned and covered with the cut out material and other scrap to create a head like structure covered with bark.

2. The Relevant Technology

It has long been a practice to harvest and display the antlers and/or horns of any animal that grows and or maintains horns or antlers. The list of animals (typically or often the male of the species) from which antlers or horns are harvested includes virtually every animal that grows or develops horns or antlers which one wants to put on display. Examples of such animals include the antlers from deer, elk, moose, antelope, mountain sheep, caribou, buffalo, impala, kudu, wildebeest, cape buffalo, water buck and so on. The horns or antlers are sometimes mounted for display for a variety of reasons including instructional purposes, decorative purposes, and religious purposes and as trophies.

In some cases, the horns and antlers the animal head is harvested with the horns or antlers and preserved or presented by taxidermy. In other cases, the horns, and/or antlers are separated from the animal after it has been harvested and then displayed on a plaque or similar structure. Various kits used for mounting antlers can be found on the internet by accessing web sites such as www.ebay.com, www.amazon.com/sports, www.walmart.com/lp/Hunter; and www.cabelas.com. While the use of plaque structure is typical other structures are shown including a lamp, a synthetic skull, a synthetic animal head, and even a table mounting support. None of the structures known to applicant present the appearance of a natural material reflective of the environment from which the animal may have been harvested.

From another perspective, existing structures for presenting or displaying antlers or horns involve decorative finished surfaces and structures are not reflective of the environment from which the animal was harvested. It is also believed that existing structures are less environmentally acceptable in that synthetic or treated materials are used that are not viewed as environmentally compatible.

### BRIEF SUMMARY

A structure for mounting antlers has a base formed with a cut out and a filler. The antlers include a right antler structure having a right root which is formed of a solid material having a right thickness with a right inner surface that is concave and a right outer surface from which the right antler extends and a left antler structure having a left root which is formed of a solid material having a left thickness with a left inner surface that is concave and a left outer surface from which the left antler extends. The term antler typically refers to bone that is an extension of the skull of the animal (e.g., deer and deer family). In some animals similar structure is horn (e.g., impala). In this application the term antler is used to refer to both antlers and horns of animals that one may wish to mount or display.

The base of the structure for mounting is formed from a natural material having a bark like exterior surface. The base has a front side that is arcuate. The base has a top and a bottom.

The cut out is formed in the bark like surface. A user can use a knife or similar structure to cut out the desired shape and then peel off the bark like material or use a scraper to separate the bark like material from the underlying surface. With the bark like material removed, the underlying surface becomes a support surface. The removed bark is referred to as a first scrap as it may be reused. The cut out has an area sized to receive said right root and said left root which are spaced apart from each other a preselected distance. The area is sized to form a fill area after positioning of said right root and said left root in the area.

A filler is sized and shaped to fit into and fill the fill area.

In a preferred arrangement, the base is section of a tree having bark that is removable. It may also be a large bush. In typical applications the tree is a lodge pole pine tree. It may be a cylindrical section with a bottom that is configured for positioning on a support surface (e.g., floor or surface of a table or desk) or a piece that is substantially semicircular in cross section that may be laid on a support surface or hung on a wall.

In some configurations the cut out has a shape which in projection is the profile of a selected animal head like the animal from which the antlers were harvested.

In some configurations, the filler has an inner surface and an outer surface. The inner surface is formed or shaped to fit against said arcuate surface of said base. Thus the inner surface is concave. The inner surface of the filler is secured to said base by any suitable means preferably by an adhesive such as an epoxy. The outer surface of the filler is covered with bark That is, the first scrap and any other scraps needed to cover the filler are glued to the outer surface by a suitable adhesive. At least one second scrap may be harvested from the base and attached to the outer surface of the filler by adhesive.

A method of forming a structure with antlers mounted thereto has several steps. A right antler structure is obtained that has a right root which is formed of a solid material having a right thickness with a right inner surface that is concave and a right outer surface from which the right antler extends. A left antler structure is also obtained that has a left root which is formed of a solid material having a left thickness with a left inner surface that is concave and a left outer surface from which the left antler extends.

A base is provided that is formed from a natural material having a bark-like exterior surface. The base has a front side oriented that is arcuate.

A cut out is formed in the bark-like surface wherein said bark-like material is removed to form a first scrap and a first mounting surface. The cut out is formed to have an area sized to receive the right root and the left root spaced apart from each other a preselected distance to reflect the spacing of the left antler and right antler on the animal from which they came. The area is sized to form a fill area after positioning of the right root and the left root in the area. The fill area is sized and shaped to reflect the projection of the head of the animal from which said right antler and said left antler were harvested. The right root is positioned with its concave surface against the convex or arcuate surface of the base or the mounting surface with the antler extending away from the base in a first direction which is typically selected to be the direction it would extend as if attached to the head of the animal. Similarly the left root is attached to the base on the first mounting surface with its antler extending away in a second direction which is normally different from and away from the first direction. The left root is spaced from said right root a preselected distance selected to reflect the distance between the left root and said right root on the animal from which left antler structure and the right antler structure were harvested. The left root and right root are preferably secured to the base with wood screws.

A filler is formed for attachment to the base in the fill area. The filler is sized and shaped to substantially fill the fill area. The filler has an interior surfaced formed to effectively mate with the mounting surface. The filler also has a filler exterior surface. The filler is attached in the fill area by any suitable means such as a suitable adhesive.

Bark is attached to the exterior surface of the filler. Thus the first scrap, the second scrap and any other scraps as necessary are used to cover the filler exterior surface.

### BRIEF DESCRIPTION OF THE DRAWINGS

To further clarify the above and other advantages and features of the present invention, a more particular description of the invention will be rendered by reference to the appended drawings. It should be understood that the drawing depicts only a typical embodiment of the invention and therefore is not to be considered limiting of the scope of the appended claims. More specifically:

FIG. 1 is an exploded perspective exploded view of a base for mounting antlers and horns;

FIG. 2 is a partial side sectional view of a base for mounting antlers;

FIG. 3 is a partial exploded side sectional view of a structure for mounting antlers;

FIGS. 4 and 4A are partial perspective views of the antler structure of the type useful for mounting on a base as seen in FIG. 1;

FIG. 5 is an exploded top plan view of a structure for mounting antlers and horns as disclosed;

FIG. 6 is a front plan view of a base for mounting antlers and horns with the cut out removed and the antlers attached;

FIG. 7 is a front plan view of a structure for mounting antlers with the antlers attached;

FIG. 8 is a photo of an actual structure for mounting antlers with the antlers attached; and

FIG. 9 is a perspective view of another structure for mounting antlers with the antlers attached.

### DESCRIPTION

A noted, it has long been a practice to harvest and display the antlers and/or horns of any animal that grows and/or maintains horns or antlers. The list of animals (typically or often the males of the species) from which antlers or horns are harvested includes virtually every animal that grows or develops horns or antlers which one may want to put on display. Male deer (bucks) have antlers or horns that are sometimes selected for display. Other animals that have antlers or horns include elk, moose, antelope, mountain sheep, caribou, buffalo, impala, kudu, wildebeest, cape buffalo, water buck and other members of the same families. Antlers are understood be bone, while horns are understood to be bone covered with other materials. So while different, they are similar. So unless otherwise clear from the context, and to avoid complication and confusion in the application and claims that follow, the term “antler” is being used hereafter in its broadest sense and is intended to include horns of those animals that have horns like bovines, buffalo and the like.

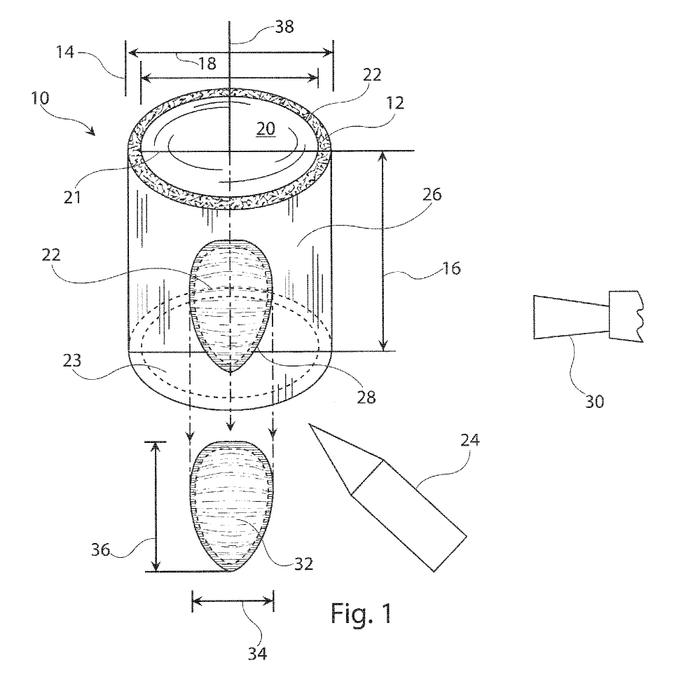

Turning now to FIG. 1, a base 10 is shown which has a bark like exterior 12. The bark like exterior 12 is made of a material of the type that it may be cut with a knife or similar tool. That is, the bark like exterior is intended to be like tree bark that can be removed from a tree leaving a solid surface which for a tree is solid wood. The bark like exterior 12 has a thickness 14 and completely covers or surrounds the base 10 which is here shown to be substantially cylindrical in shape having a height 16 and a diameter 18. While the base 10 is shown to be cylindrical, it should be understood that the base 10 may be elliptical otherwise non circular while having an arcuate face 26. The base 10 may even have one or more faceted faces I (not shown). The base 10 has a core 20 that presents a mounting surface 22 that is exposed when the bark like exterior 12 is removed. The core 20 here is shown to be solid with a top 21 and a bottom 23, but it may be hollow as long as it presents a mounting surface 22 of sufficient strength and thickness for mounting antlers as hereinafter discussed.

As seen in FIG. 1, a sharp tool like a knife 24 may be used to cut the bark like material 12 to form a cut out 28 which can be seen to be generally in the form or shape of an animal head. That is, the knife 24 is used to cut through the hark like material 12 down to the mounting surface 22 while another tool like scraper 30 is used to pry the bark like material from the mounting surface 22. The bark like material 12 that is removed forms a first scrap 32. While the first scrap 32 is shown as a single piece, it may be in multiple pieces depending on the skill of the user removing the bark like material 12. The cut out 28 has a width and a height which is comparable to the width 34 and height 36 of the first scrap 32. The height 36 and width 34 are selected to approximate the height and width of an animal head that is related to the actual height and width of the animal from which antlers are harvested. It may not be the same size as or even proportional, but it would be sized to be generally suggestive of the head of the animal from which the antlers are harvested.

In FIG. 1, it may be noted that the bottom 23 is generally flat and in fact normal to the axis 38 of the base 10. However, it may be noted that the bottom 23 may in any shape so long as it provides stable support to the structure for mounting antlers with the antlers attached as herein after discussed. In some cases, one may desire to put protective feet on the bottom 23 to protect a support surface upon which the base 10 is positioned. The top 21 is also shown as flat or in a configuration so that one may position other items on the top 21 if desired.

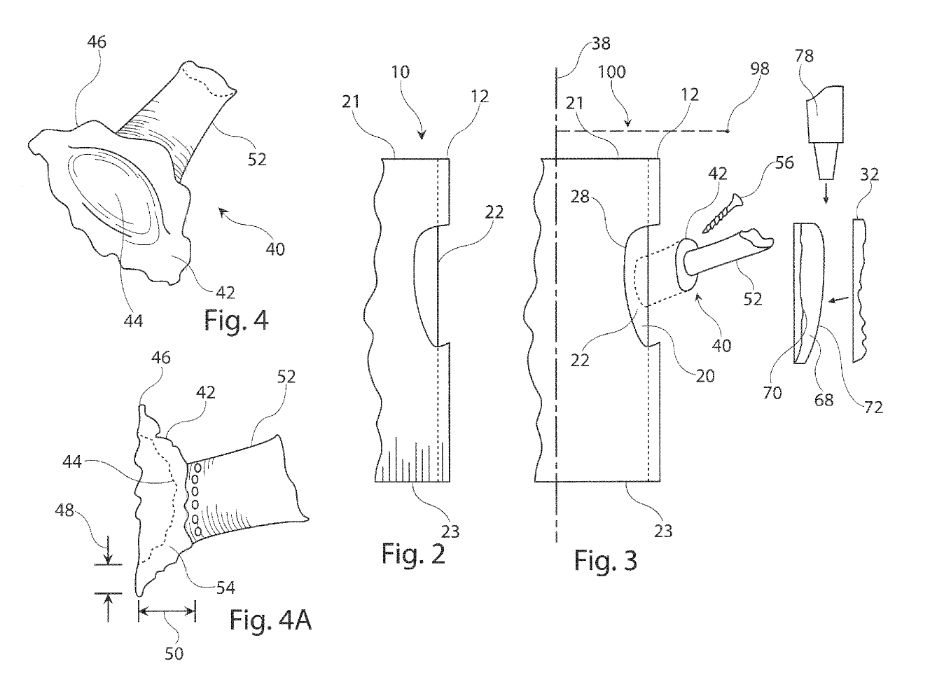

Turning now to FIGS. 2 and 3, the base 10 is shown in partial side view with the cut out 28 made and the first scrap 32 removed. The cut out 28 reveals the arcuate mounting surface 22 of the core 20. In FIG. 3, it can be seen that the left antler structure 40 of a pair of antlers is positioned broken away for mounting to the base 10 within the cut out 28. The antler structure 40 is shown in FIGS. 4 and 4A to have a root 42 that is concave. That is, the antler structure is harvested from the animal so that it has a root 42. The root 42 has an inner surface 44 that is dished inwardly and can be said to be concave. The root 42 is also has a perimeter 46 which is generally circular in projection. The root 42 has a thickness 48 which is formed of solid material and a height 50 so that the root 42 may be positioned snuggly and generally register against the mounting surface 22. The antler itself 52 extends from the exterior surface 54 away presenting points or other structure. The left antler structure and the right antler structure from an actual animal are different but are also quite comparable to the antler structure 40 shown in FIGS. 4 and 4A. However, it they will differ as the left hand differs from the right hand of a user. That is, they are mirror images and differ as the animals are believed to have slightly different antlers on both sides.

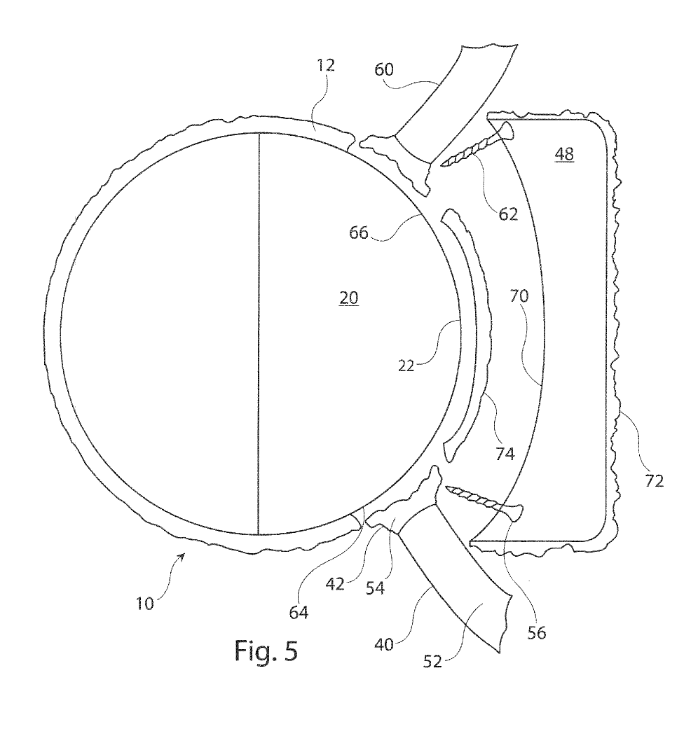

As seen in FIG. 3, the antler structure 40 is positioned for association with the mounting surface 22 in the cut out 28 where it is to be secured using a suitable fastener such as the screw 56. A hole may be pre drilled into the core 20 by a suitable drill to snuggly and securely receive the screw 56. The antler structure 40 and the right antler structure 60 are shown being mounted to the mounting surface 22 in FIG. 5 with screws 56 and 62 that are inserted or urged into the core 20 of the base 10. The cut out 28 has an area 64 selected to accept the antler structures 40 and 60 plus have additional area for presenting a representation of an animal head. The additional area remaining after mounting the antler structures 40 and 60 is fill area 66.

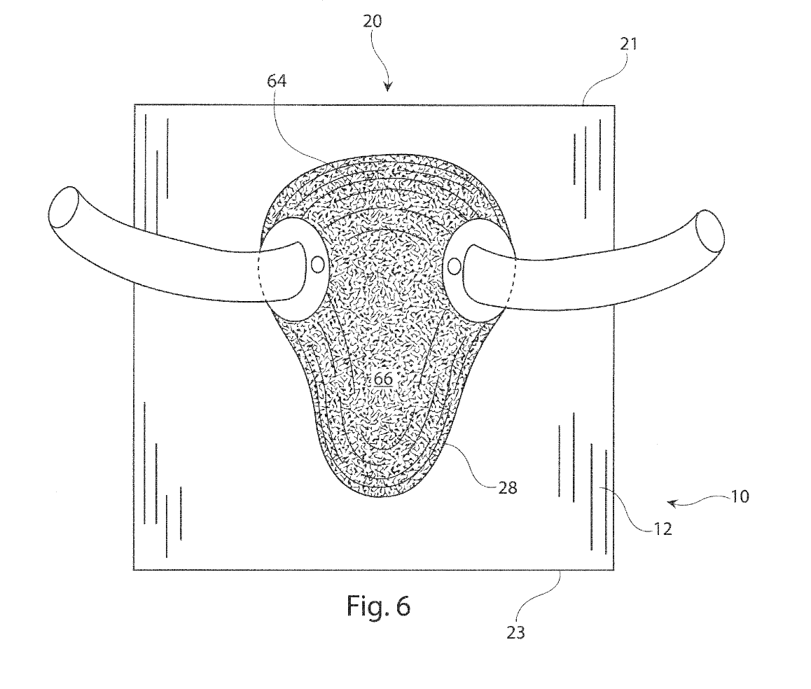

As seen in FIGS. 3 and 5, a filler 68 is sized for positioning in the fill area. That is, the filler 68 is made of a suitable low cost light weight material which is easy to shape by cutting and trimming. A polystyrene foam has been found to be suitable. The filler 68 has an interior surface 70 and an exterior surface 72. The interior surface 70 is cut or shaped so that it is registerable with the mounting surface 22 in the fill area 66. (FIG. 6). It is also shaped to fit over and around the antler structure 40 and 60 as hereinafter discussed. Upon shaping, the filler 68 is affixed to the mounting surface 22. While it may be screwed or stapled or similarly mechanically affixed, it is preferred to affix the filler 68 to the mounting surface 22 with an adhesive 74. The adhesive 74 may be applied from a suitable tube. A simple epoxy adhesive has been found to be adequate.

Either before or after affixing the filler 68 to the mounting surface 22, the first scrap 32 is affixed to the outer surface 72 of the filler 68. While other mechanical means of affixing the first scrap 32 to the outer surface 72 may be used such as small nails, brads or screws, it is preferred to affix the first scrap to the outer surface 72 with a suitable adhesive such as an epoxy supplied from a tube 78 or other disperser/source. The first scrap 32 may need to be cut using a sharp instrument like knife 26 to fit onto the filler 68 creating more scraps. A plurality of scraps from the first scrap 32 as well as from other parts of the base 32 are used to fully cover all of the outer surface 72 of the filler 68. With the filler 68 fully covered or substantially fully covered with scraps including the first scrap 32, it presents an appearance of the exterior bark like surface 12 of the base 10. Inasmuch as the exterior bark like surface 12 is representative of the environment from which the animal with the antlers is associated, the structure for mounting with the antlers has the appearance of the selected environment.

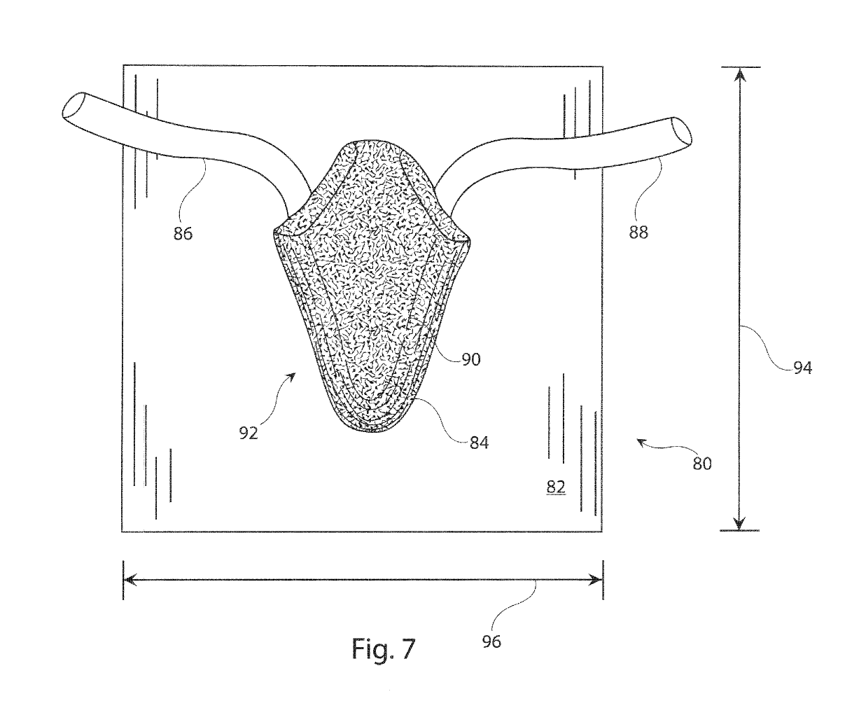

In FIG. 7, the base 80 is a piece of a real tree with bark. The piece may be from a limb or from the trunk so long as it has a suitable covering of bark. The piece has a height 94 and a width which is really the effective diameter 96 inasmuch as the base 80 is essentially cylindrical and in turn essentially circular in cross section. That is, the base 80 may not be perfectly round and could even be somewhat elliptical or pear shaped in cross section.

The height of the base like height 94 is variable and is selected to be generally related to size the antlers to be mounted. If the antlers are mounted to a base, the antlers will have a height from the root to the top and a width that extends from the outside of the antlers when looking at the filler like filler 68. The antlers will also have a center of mass or gravity like center of gravity 98 (FIG. 3) creating a lever arm like lever arm 100 (FIG. 3) that is supported by a wall if the base is cut in half along its axis (like axis 38) or cut along a line parallel to that axis to create an essentially flat back surface so it can be hung on a wall. A small indentation can be made in the essentially flat back surface to register with a suitable hanger. The hack surface may be rough cut so that it is not flat. It may even be a little convex or concave and still be positionable against a wall or similar flat surface. In another configuration, the base like base 80 and base 10 are sized in height and diameter so that with the antlers and the filler attached, the center of gravity of the combination is such that the structure for mounting with the antlers attached is stable and will not tip when the bottom like bottom 23 is positioned on a support surface.

As noted before the base like base 80 may be essentially cylindrical in shape with a flat bottom like bottom 23. The bottom may be cut at an angle to tilt the base like base 80, if desired. This can be done for aesthetic appearance and to move the center of gravity to stabilize the structure for mounting with the antlers attached.

For small antlers, the base like base 80 may be sized (e.g., from about 18 inches to about 24 inches in height with a diameter or effective diameter (or width) from about 10 to about 14 inches). That is, the base may be essentially cylindrical or it may be cut along or parallel to its axis. With the base having a flat bottom and small antlers, it will still stand on a support surface.

As apparent from the discussion above, the lever arm of the antlers may also be counterbalanced by the weight of the base like base 80 as it has a mass and a center of gravity. That is, the base 80 is sized to have a mass and center of gravity to have a lever arm that balances the lever arm of the antlers. The result is a center of gravity for the combination of the structure for supporting the antlers and the antlers like that seen in FIG. 7 will be toward the axis like axis 38 and in from the support surface like support surface 22 so it is stable and upright when positioned on a suitable support surface.

Also, it may be noted, that the lever arm of the antlers can be adjusted by forming the cut out (like cut out 28) larger so the root of the antlers are farther apart in turn shortening the arm of the lever arm like lever arm 100.

As shown base 80 is made from a lodge pole pine tree. That is the base 80 is taken from a lodge pole pine by using a saw and cutting a large limb or the trunk. The base 80 has bark on it which can be removed with a sharp tool like knife 24. In some cases, the user may be able to pull the bark off by hand and in others may need to use a scraper 30 to separate the bark from the support surface like support surface 22. In turn the user will form the cut out 84 comparable to cut out 28. A left antler structure and a right antler structure are mounted to the base 80 in the cut out 84 in a manner similar or comparable to the mounting of left antler structure 40 and right antler structure 60. In FIG. 7, the left antler 86 of left antler structure and right antler 88 of right antler structure are visible. The roots are not visible as they are under the filler 90 which has been glued into the fill area comparable to fill area 66. The filler 90 has an exterior surface that has been covered with the first scrap and other scraps to present a finished and uniform appearance of an animal head 92 reflective of the animal from which the antlers were harvested. The use of the bark on the filler suggests that the antlers came from the wooded environment of the tree or a natural environment.

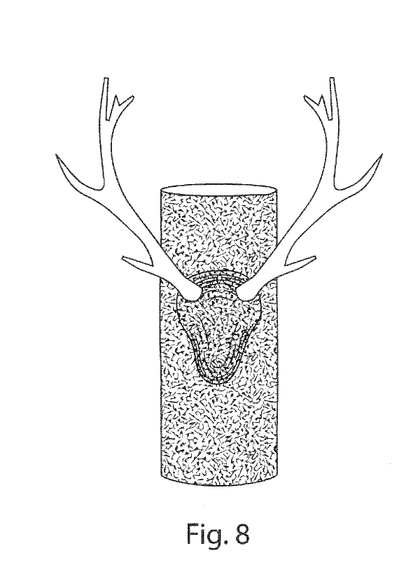

FIG. 8 is a photograph of an actual structure for mounting antlers that has a visible base like base 80 made from a lodge pole pine. The antlers are visible and mounted to the base. A filler has been formed in the shape of an animal head with scraps affixed to the exterior. The filler with the scraps affixed is attached in the fill area to present a mounting without the head of the animal but suggestive of a natural wooded environment.

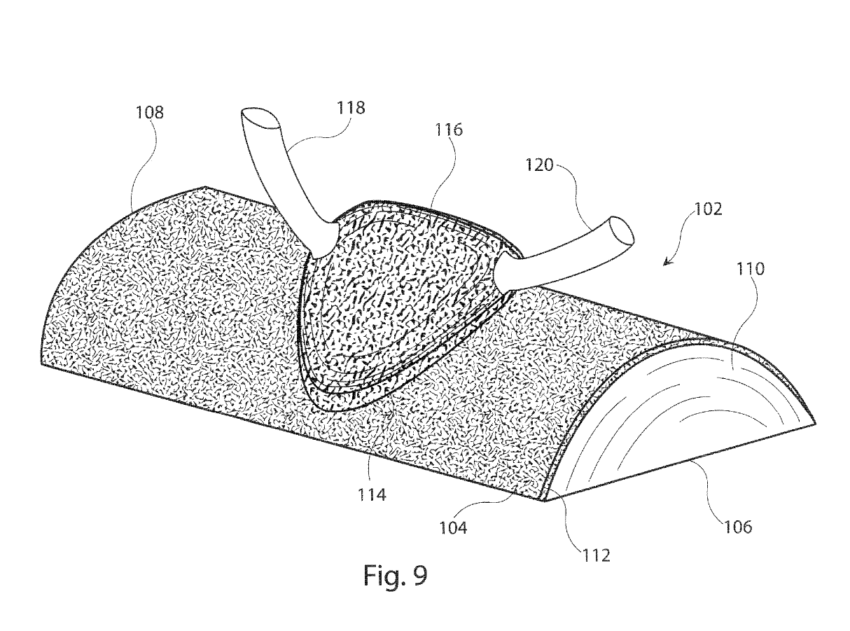

FIG. 9 is an alternate configuration in which the base 102 is semicircular in cross section presenting an arcuate outer surface 104. It is formed here to have a flat bottom 106 and opposite sides like left side 108 and right side 110. The base is made of a tree with bark like a lodge pole pine. The bark 112 is cut and removed to form a cut out 114 in which the antler structure is mounted. A filler 116 is formed and positioned in the fill area comparable to fill area 66. The antler structure includes roots secured to the support surface comparable to support surface 22 and have antlers 118 and 120 which outwardly form the cut out with the filler 116 formed to be thereabout. While the base 102 of FIG. 9 is seen as a half cylinder, it should be understood that the base may have rounded sides 108 and 110 and a hollow bottom 106. The base 102 may also be formed to be in other shapes which can even be generally spherical.

To form a structure for mounting antlers with the antlers attached, the antlers are first harvested from animal. With the antlers known, then a base like base 10 is obtained by, for example, cutting section from the trunk of a lodge pole pine or other tree or tree limb having bark. The size is selected in relation to the antlers and is preferably under four feet in height like height 36. Typically, the height will be from about 1.5 feet to 2.5 feet.

After selecting and cutting to form the base like base 10, the cut out is formed using a suitable knife like tool. The cut out may be the outline of an animal head. However, it may also be the form of a desired geometrical shape. The bark is removed to reveal the mounting surface like surface 22. The bark is scrap; and it is saved for later use as it will be attached to the exterior of the filler.

The root (like root 42) of each of the two antlers are then mounted to the base using at least one screw like screw 56. Multiple screws may be needed in selected applications. Thereafter, the filler like filler 68 is shaped to fill the remaining area or the fill area of the cut out. The shaping may be done using any suitable tool including scissors, knives and the like. The filler is a light weight material easy to work with and shape. Polystyrene is preferred but other forms of foam like material should also be acceptable.

The filler is then affixed into the cut out to fill the fill area and present the desired shape. It can be affixed mechanically by screws or brads or the like, but is preferably glued by the use of a suitable epoxy adhesive.

The bark or scraps may be affixed to the exterior surface of the filler either before or after the filler is affixed to the support surface of the base in the fill area. The bark or scraps are preferably glued by a suitable epoxy adhesive to the outer surface of the filler Additional scraps or bark may be taken from other parts of the tree not used for the base to present a covered surface so that the shape of the filler blends visually with the outer surface (bark) of the base.

Those skilled in the art will recognize disclosed structures and methods may be practiced using materials that may be different from those identified hereinabove without departing from the principles as disclosed. Only specific embodiments have been disclosed to illustrate the structures and methods as defined by the appended claims.

What is claimed is:

1. A structure for mounting a right antler structure having a right root which is formed of a solid material having a right thickness with a right inner surface that is concave and a right outer surface from which the right antler extends and a left antler structure having a left root which is formed of a solid material having a left thickness with a left inner surface that is concave and a left outer surface from which the left antler extends, said structure comprising:
a base formed from a material having a bark-like exterior surface, said base having a front side that is arcuate and extends between a left edge and a right edge, said base having a bottom and a top;
a cut out formed in said bark-like exterior surface wherein said material is removed to form a first scrap, said cut out having an area sized to receive said right root and said left root which are spaced apart from each other a preselected distance, said area being sized to form a fill area after positioning of said right root and said left root in said area; and
a filler attached to said base in said fill area, said filler being sized and shaped to substantially fill said fill area.

2. The structure of claim 1 wherein said base is section of a tree having bark that is removable.

3. The structure of claim 2 wherein said tree is a lodge pole pine tree.

4. The structure of claim 3 wherein said base is a section of a lodge pole pine tree which is substantially semicircular in cross section.

5. The structure of claim 3 wherein said section is cylindrical with a bottom that is formed for stable positioning on a support surface.

6. The structure of claim 1 wherein said cut out has a projection which is the profile of a selected animal head.

7. The structure of claim 1 wherein said filler has an inner surface and an outer surface, wherein said inner surface is formed to be concave to fit against said arcuate surface of said base, wherein said inner surface of said filler is secured to said base by an adhesive and wherein said first scrap is secured to said outer surface of said filler by an adhesive.

8. The structure of claim 7 further including at least a second scrap secured to said outer surface of said filler by adhesive, said first scrap and said second scrap together having an area to substantially cover the outer surface of said filler.

9. The structure of claim 8 wherein said filler is made of polystyrene foam material.

10. The structure of claim 1 wherein said left root and said right root are each securable to said base by screws.

11. A structure for mounting a right antler structure having a right root which is formed of a solid material having a right thickness with a right inner surface that is concave and a right outer surface from which the right antler extends and a left antler structure a left root which is formed of a solid material having a left thickness with a left inner surface that is concave and a left outer surface from which the left antler extends, said left antler and said right antler together having a mass and a center of mass, said left antler and said right antler have a height, a width and a depth to form, when mounted, a frontal lever arm and a transverse lever arm, said structure comprising:
a base formed from a section of lodge pole pine with a bark as an exterior surface, said base being formed with a bottom configured for stably supporting said structure on a support surface;
a cut out formed in said bark wherein said bark is removed to form a first scrap and reveal a first mounting surface, said cut out having an area sized to receive said left root and said right root spaced apart from each other a preselected distance and for attachment to said first mounting surface, said area being sized to form a fill area in the shape of a preselected animal head after securement of said right root and said left root in said area; and
a filler attached to said base in said fill area, said filler being sized and shaped as a preselected animal head to substantially fill said fill area, said filler having a surface to which said first scrap is mounted.

12. A method of forming a structure with antlers mounted thereto, said method comprising:
providing a right antler structure having a right root which is formed of a solid material having a right thickness with a right inner surface that is concave and a right outer surface from which the right antler extends;
providing a left antler structure having a left root which is formed of a solid material having a left thickness with a left inner surface that is concave and a left outer surface from which the left antler extends;
providing a base formed from a material having a bark like exterior surface, said base having a front side that is arcuate, said base having a bottom and a top;
forming a cut out in said bark like surface wherein said bark-like material is removed to form a first scrap and to form a first mounting surface, said cut out having an area sized to receive said right root and said left root spaced apart from each other a preselected distance, said mounting surface being sized to form a fill area after positioning of said right root and said left root to said mounting surface, said fill area being sized and shaped to reflect the projection of the head of the animal from which said right antler and said left antler were harvested;
attaching said right root to said base on said first mounting surface with said antler extending away from said base in a first direction;
attaching said left root to said base on said first mounting surface with said antler extending away from said base in a second direction away from said first direction, said left root being spaced from said right root a preselected distance selected to reflect the distance between said left root and said right root on the animal from which said left antler and said right antler were harvested;
forming a filler for attachment to said base in said fill area, said filler being sized and shaped to substantially fill said fill area, said filler having an interior surfaced formed to effectively mate with the exterior mounting surface and a filler exterior surface;
securing said filler to said fill area;
attaching said first scrap to said filler exterior surface;
forming at least one additional second scrap to match the appearance of said first scrap; and
attaching said second scrap to said filler exterior surface.
